(19) United States
(12) Patent Application Publication
(10) Pub. No.: US 2008/0186373 A1
(43) Pub. Date: Aug. 7, 2008

(54) Inkjet ink composition

(76) Inventor: Luanne J. Rolly, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/529,876

(22) Filed: Sep. 29, 2006

(51) Int. Cl. C09D 11/10; B05D 5/00; B41J 2/01; B05D 1/00

(52) U.S. Cl. 347/100; 524/556; 347/105; 523/122; 427/466; 427/256

(57) ABSTRACT

A inkjet ink composition includes an acrylic latex, a solvent, 1,2-hexanediol, a colorant, a dispersant, and water. The acrylic latex is present in an amount ranging from about 1 wt. % to about 5 wt. %. The solvent is selected from dipropylene glycol monomethyl ether,.tetrahydrofurfuryl alcohol, propylene glycol monopropyl ether, and combinations thereof, and is present in an amount ranging from about 6 wt. % to about 10 wt. %. The 1,2-hexanediol is present in an amount ranging from about 0.5 wt. % to about 2 wt. %, and the colorant is present in an amount ranging from about 0 wt. % to about 6 wt. %.

### BACKGROUND

The present disclosure relates generally to inkjet ink compositions.

Thermal inkjet printers use resistors to create heat, which in turn vaporizes ink to form a bubble. As the bubble expands, some of the ink is pushed out of the nozzle. A vacuum is created when the bubble collapses, which pulls more ink from the cartridge into the print head.

Inks that are predominantly water-based generally may not perform well in thermal ink jet printers. Poor performance may result because rapid water evaporation often leads to poor nozzle reliability (i.e., a crust of dried ink may clog the nozzle due to rapid water evaporation).

Predominantly non-aqueous solvent-based inks (i.e., inks made with solvents having a higher vapor pressure than water) generally have faster dry times than aqueous inks on non-absorbent substrates, due, at least in part, to higher vapor pressure and lower delta-H evaporation values. Non-aqueous solvent-based inks may, however, be undesirable. This may be due, at least in part, to the amount of volatile organic compounds that may be present in such inks; the potentially high volatility of such inks; and/or the potential incompatibility of such inks with adhesives and polymers. Non-aqueous solvent-based inks may also limit the materials suitable for constructing the printhead, as some of the solvents may be capable of ruining the printhead.

Combination aqueous- and solvent-based inks generally include enough of a low vapor pressure/high boiling point solvent to assist in controlling nozzle reliability. As the water in these inks evaporates, the solvents tend to remain in the firing chamber in order to keep the colorants and other materials in the ink solubilized. However, the quantity of solvent generally used to achieve nozzle reliability does not evaporate readily, thereby increasing dry times on non-absorbent substrates.

### DETAILED DESCRIPTION

Embodiments of the inkjet ink composition disclosed herein are predominantly aqueous-based inks that are suitable for drop-on-demand thermal and piezoelectric inkjet printing. The inkjet ink composition disclosed herein advantageously exhibits good smudge and/or abrasion resistance, enhanced decap performance, good nozzle health, better drop formation and ejection than inks based on water alone, and has a decreased dry time (i.e., unassisted air drying) when printed on non-absorbent media.

The term “decap,” as referred to herein, means the ability of the inkjet ink to readily eject from the print head, upon prolonged exposure to air. The ink decap time is measured as the amount of time that an ink printhead may be left uncapped before the printer nozzles no longer fire properly, potentially because of clogging or plugging. Generally, the nozzle(s) may become clogged/plugged by a viscous plug that forms in the nozzle(s) as a result of water loss, crusting of the ink, and/or crystallization of the dye in and/or around any of the nozzles. If a nozzle has plugged, ink droplets ejected through the nozzle's orifice may be misdirected, which may adversely affect print quality. The orifice may also become completely blocked, and as a result, the ink droplets may not pass through the affected nozzle.

Without being bound to any theory, it is believed that the combination of a relatively large amount of water and a relatively small amount of specific solvents aids in achieving good nozzle health, good decap performance, and reliable drop formation/ejection, without deleteriously impacting the dry time of the ink on non-absorbent media. It is further believed that the acrylic latex advantageously enhances smudge resistance of the printed ink once dry.

An embodiment of the thermal inkjet ink composition includes 1,2-hexanediol; a solvent; an acrylic latex; a colorant; a dispersant; and a balance of water.

Generally, 1,2-hexanediol is present in the ink composition in an amount ranging from about 0.5 wt. % to about 2 wt. %. Without being bound to any theory, it is believed that, after the ink composition is fired and the nozzle is idle, the relatively small amount of 1,2-hexanediol is capable of concentrating at the air-ink interface in the nozzle. It is believed that this may be due, at least in part, to the fact that the 1,2-hexanediol is considered a quasi-surfactant having a hydrophilic end and a hydrophobic end. It is further believed that this substantially reduces the rate at which water loss occurs; thereby substantially preventing crusting of the nozzle and enhancing decap performance and nozzle reliability.

In an embodiment, the total solvent concentration in the ink composition ranges from about 6 wt. % to about 10 wt. %. The solvent is selected from dipropylene glycol monomethyl ether, tetrahydrofurfuryl alcohol (also known as tetrahydro-2-furanmethanol [97-99-4]), propylene glycol monopropyl ether, and combinations thereof. It is believed that the small amount of solvent, in combination with the 1,2-hexanediol, advantageously assists in maintaining nozzle health without negatively impacting the dry time of the ink when printed. Furthermore, it is believed that the small amount of solvent(s) achieves reliable drop formation and ejection.

The acrylic latex may be present in an amount ranging from about 1 wt. % to about 5 wt. %. A non-limiting example of the acrylic latex includes polymer colloid particulates having surface acid groups which tend to be more stable over longer periods of time, and tend to resist aggregation. Examples of such polymer colloid particulates are further described in U.S. patent application Ser. No. 10/772,792, published as U.S. Patent Publication No. 2005/0176847 on Aug. 11, 2005, which is incorporated herein by reference in its entirety.

Without being bound to any theory, it is believed that the latex forms a thin film while incorporating the colorant(s), thereby enhancing the smudge resistance of the ink.

The inkjet ink composition also includes a colorant. Generally, the amount of colorant ranges from about 0 wt. % to about 6 wt. %. In an embodiment, the colorant amount ranges from about 3 wt. % to about 6 wt. %. Suitable colorants include pigments, dyes, or combinations thereof. The pigments may be nonionic, cationic, anionic, or combinations thereof, while the dyes may be cationic and/or anionic.

As used herein, the term “pigment” refers to a colorant particle that is substantially insoluble in the liquid vehicle in which it is used. Suitable pigments include self-dispersed pigments and non self-dispersed pigments. Self-dispersed pigments include those that have been chemically modified at the surface with a charge or a polymeric grouping. This chemical modification aids the pigment in becoming and/or substantially remaining dispersed in a liquid vehicle. A non-self-dispersed pigment utilizes a separate and unattached dispersing agent (e.g., polymers, oligomers, surfactants, etc) in the liquid vehicle or physically coated on the surface of the pigment.

In an embodiment, the pigment is a self-dispersible anionic pigment. A pigment precursor is chemically modified to impart water-dispersiblity to the precursor. Such modifications include the incorporation of carboxylate and/or sulfonate functionalities. In an embodiment, the anionic pigments are associated with Na⁺, Li⁺, K⁺, and NH₄⁺ cations, although any suitable counterion may be used herein. A non-limiting example of a self-dispersible pigment is CAB-O-JET 300, which is commercially available from Cabot Corporation located in Boston, Mass.

Examples of suitable black pigments include Raven 7000, Raven 5750, Raven 5250, Raven 5000, and Raven 3500 (all of which are commercially available from Columbian Chemicals, Co. located in Marietta, Ga.). Other examples of suitable black pigments include Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4 (all of which are commercially available from Degussa Corp. located in Parsippany, N.J.).

Many colored pigments are capable of being modified via the attachment of organic group(s). Suitable classes of colored pigments include, but are not limited to anthraquinones, phthalocyanine blues, phthalocyanine greens, diazos, monoazos, pyranthrones, perylenes, heterocyclic yellows, quinacridones, and (thio)indigoids. Non-limiting examples of phthalocyanine blues include copper phthalocyanine blue and derivatives thereof (e.g., PB15). Examples of quinacridones include, but are not limited to pigment orange (PO) 48, PO49, PR122, PR192, PR202, PR206, PR207, PR209, pigment violet (PV) 19, PV42, or combinations thereof. Non-limiting examples of anthraquinones include PR43, PR194 (perinone red), PR216 (brominated pyrathrone red), PR226 (pyranthrone red), or combinations thereof. Perylene pigment examples include, but are not limited to PR123 (vermillion), PR149 (scarlet), PR179 (maroon), PR190 (red), PR189 (yellow shade red), PR224, or combinations thereof. Non-limiting examples of thioindigoids include PR86, PR87, PR88, PR181, PR198, PV36, PV38, or combinations thereof. Examples of suitable heterocyclic yellow pigments include, but are not limited to PY117, PY138, or combinations thereof. Examples of other suitable colored pigments are described in Colour Index, 3rd edition (The Society of Dyers and Cikiyrusts, 1982). The pigments listed herein are examples of suitable pigments; however, it is to be understood that other pigments may be suitable for embodiments of the inkjet ink composition.

Non-limiting examples of suitable dyes include direct yellow 86; acid red 289; direct blue 41; direct blue 53; direct blue 199; direct black 168; direct yellow 132; the Duasyn® line of dyes available from Clariant located in Coventry, R.I.; direct black 168; reactive black 31; direct yellow 157; reactive yellow 37, acid yellow 23; reactive red 180; direct red 28; acid red 52; acid red 91; acid black 1; acid green 3; acid green 5; acid green 50; direct blue 199; acid blue 1; acid blue 9; acid blue 34; acid blue 90; acid blue 93; acid blue 104; reactive red 4; reactive red 56; acid red 92; or combinations thereof.

Further non-limiting examples of suitable dyes include Tricon acid red 52, Tricon direct red 227, Tricon acid yellow 17, Yellow Shade 16948 (all of which are commercially available from Tricon Colors Inc., located in Elmwood Park, N.J.); Pergasol® Yellow CGP, Orasol®) Black RL (Ciba-Geigy), Orasol® Black RLP (all of which are commercially available from Ciba Specialty Chemicals, located in Tarrytown, N.Y.); Levafix® Brilliant Yellow E-GA, Levafix® Yellow E2RA, Levafix® Black EB, Levafix® Black E-2G, Levafix® Black P-36A, Levafix® Black PN-L, Levafix® Brilliant Red E6BA, and Levafix® Brilliant Blue EFFA (all of which are commercially available from DyStar Textilfarben GmbH, located in Frankfurt, Germany); Procion® Turquoise PA, Procion® Turquoise HA, Procion® Turquoise Ho5G, Procion® Turquoise H-7G, Procion® Red MX-5B, Procion® Red H8B (Reactive Red 31), Procion® Red MX 8B GNS, Procion® Red G, Procion® Yellow MX-8G, Procion® Black H-EXL, Procion® Black P-N, Procion® Blue MX-R, Procion® Blue MX-4GD, Procion® Blue MX-G, and Procion® Blue MX-2GN (all of which are commercially available from DyStar Textilfarben GmbH). The dyes listed herein are examples of suitable dyes, however, it is to be understood that other dyes may be suitable for embodiments of the inkjet ink composition.

It is to be understood that the dye may be color matched with the pigment (e.g., magenta dye with magenta pigment). Alternately, the dye and pigment may be different colors (e.g., magenta pigment with cyan dye). The dye may be present in an amount ranging from about 0.5 wt. % to about 2 wt. %. It is believed that the dye increases the chroma and saturation of the printed ink on various forms of media.

A dispersant may also be included in the ink composition to aid in dispersion of the colorant. Generally, the dispersant is present in an amount ranging from about 0.4 wt. % to about 0.6 wt. % of the weight of the pigment. One class of dispersants suitable for use in embodiments of the ink composition includes those having a molecular skeleton of a styrene/acrylic acid copolymer resin. Generally, the dispersant has an acid number greater than or equal to 100, and a molecular weight equal to or less than 20,000. Specific examples of suitable dispersants include those manufactured by BASF Corp., located in Florham Park, N.J., under the tradenames Joncryl 680 (molecular weight 4,900, acid value 215), Joncryl 682 (molecular weight 1,700, acid value 238), Joncryl 586 (molecular weight 4,600, acid value 108), Joncryl 683 (molecular weight 8,000, acid value 160), Joncryl 678 (molecular weight 8,500, acid value 215), Joncryl 671 (molecular weight 17,250, acid value 215), or combinations thereof.

The ink composition may also include other additives. Non-limiting examples of such additive include water soluble polymers, surfactants (e.g., non-ionic surfactants, ethoxylated nonionic fluorosurfactants, etc.), buffers, biocides, sequestering agents, viscosity modifiers, surface-active agents, chelating agents, resins, and/or combinations thereof.

The balance of the inkjet ink composition is water.

Forming embodiment(s) of the inkjet ink composition includes providing or making the ink vehicle (e.g., solvents, acrylic latex, water), and adding the effective amount of colorant thereto.

In an embodiment of a method of using embodiment(s) of the inkjet ink composition, the ink composition is established on at least a portion of a substrate to form an image. The amount of the ink composition established depends, at least in part, on the desirable image to be formed. The image may include alphanumeric indicia, graphical indicia, or combinations thereof. A non-limiting example of a suitable inkjet printing technique includes thermal inkjet printing or piezoelectric inkjet printing. Suitable printers include portable thermal or piezoelectric inkjet printers (e.g., handheld printers, arm mountable printers, wrist mountable printers, etc.), desktop thermal or piezoelectric inkjet printers, or combinations thereof.

When embodiments of the ink are established on non-absorbent substrate materials, the dry time is equal to or less than about 20 seconds. It is to be understood that the dry time may vary slightly, depending, at least in part, on the font and print density. Examples of suitable non-absorbent substrates (some of which may also be non-porous substrates) include, but are not limited to vinyl and other plastic sheets or films, metals, coated offset media, some wood materials, glass, and/or the like, and/or combinations thereof. Some specific non-limiting examples of such substrates include polypropylene tapes, polyester tapes, polyethylene bags, water-resistant envelopes, aluminum foil, other substrates formed from polyethylenes and/or high-density polyethylenes, and/or combinations thereof.

It is to be understood that embodiments of the inkjet ink composition disclosed herein may also be printed on absorbent substrates. Non-limiting examples of such substrate materials include, but are not limited to plain papers, microporous photopapers, coated papers, glossy photopapers, semi-gloss photopapers, heavy weight matte papers, billboard papers, digital fine art papers, calendared papers, vinyl papers, or combinations thereof.

To further illustrate embodiment(s) of the present disclosure, the following example is given herein. It is to be understood that this example is provided for illustrative purposes and is not to be construed as limiting the scope of the disclosed embodiment(s).

### EXAMPLE

Three different ink compositions were prepared. Two of the inks (ink formulas 1 and 2) represent embodiments of the present disclosure, and one of the inks (ink formula 3) is a comparative example formed without 1,2-hexanediol and with different solvents. The formulas are shown in Table 1 below.

TABLE 1
Ink Formulations

| Ink Formula 1 | | Ink Formula 2 | | Ink Formula 3 (comparative) | |
|---|---|---|---|---|---|
| Ingredient | Wt % | Ingredient | Wt % | Ingredient | Wt % |
| Dipropylene | 6% | Propylene glycol | 6% | Trimethylol propane | 10% |
| monomethyl ether | | monopropyl ether | | | |
| 1,2-hexanediol | 1.0% | Tetrahydrofurfuryl | 1.0% | 2-pyrollidinone | 6% |
| | | alcohol | | | |
| Fluorosurfactant | 1.0% | 1,2-hexanediol | 1.0% | 1,5-pentanediol | 4% |
| Magenta self- | 3.0% | Fluorosurfactant | 1.0% | Fluorosurfactant | 1% |
| dispersed pigment | | | | | |
| Acid Red 52 | 1% | Magenta self-dispersed | 3.0% | Magenta self-dispersed | 3% |
| | | pigment | | pigment | |
| Acrylic latex | 3% | Acid Red 52 | 1% | Acid Red 52 | 1% |
| Water | 85% | Acrylic latex | 3% | Acrylic latex | 3% |
| | | Water | 87% | Water | 75% |

The ink formulations were printed on a variety of non-absorbent media and on plain paper using a thermal inkjet printer. The unassisted dry time results are depicted in Table 2. The dry time was measured by wiping the printed text with a soft cloth or tissue. The text is printed at a 24 point font with a dot pattern at 25% depletion.

TABLE 2
Dry Time Results for the Ink Formulations on Different Media

| | Dry Time | | | |
|---|---|---|---|---|
| Test Substrate | Ink Formula 1 | Ink Formula 2 | Ink Formula 3 | |
| Aluminum Foil | <20 s | <20 s | >4 | hrs |
| Glass | <20 s | <20 s | >4 | hrs |
| High density polyethylene (HDPE) | <20 s | <20 s | >4 | hrs |
| Low density polyethylene (LDPE) | <20 s | <20 s | >4 | hrs |
| Biaxially oriented polypropylene tape | <20 s | <20 s | >4 | hrs |
| (BOPP) | | | | |
| Polyester film | <20 s | <20 s | >4 | hrs |
| Polyethylene terephthalate (PET) | <20 s | <20 s | >4 | hrs |
| (e.g., Mylar ®) film | | | | |
| Tyvek ® Envelope | <1 s | <1 s | <5 | s |
| Plain paper | <1 s | <1 s | <1 | s |

Generally, “<5 seconds” means that the printed ink smudges when tested at 0-1 seconds, but does not smudge at the 5-6 second point. The “<20 seconds” means that the printed ink smudges at 10-15 seconds, but does not smudge at the 20 second point. It is to be understood that the times are ±1 second.

As depicted in Table 2, the dry times for ink formulations 1 and 2 were lower than the dry times for ink formulation 3 when printed on non-absorbent substrates.

While several embodiments have been described in detail, it will be apparent to those skilled in the art that the disclosed embodiments may be modified. Therefore, the foregoing description is to be considered exemplary rather than limiting.

What is claimed is:

1. A inkjet ink composition, comprising:
an acrylic latex present in an amount ranging from about 1 wt. % to about 5 wt. %;
a solvent selected from dipropylene glycol monomethyl ether, tetrahydrofurfuryl alcohol, propylene glycol monopropyl ether, and combinations thereof, the solvent present in an amount ranging from about 6 wt. % to about 10 wt. %;
1,2-hexanediol present in an amount ranging from about 0.5 wt. % to about 2 wt. %;
a colorant present in an amount ranging from about 0 wt. % to about 6 wt. %;
a dispersant; and
water.

2. The inkjet ink composition as defined in claim 1 wherein the colorant is selected from pigments, dyes, and combinations thereof.

3. The inkjet ink composition as defined in claim 2 wherein the dispersant is selected from styrene/acrylic acid copolymer resins.

4. The inkjet ink composition as defined in claim 1 wherein when the inkjet ink composition is established on a substantially non-absorbent substrate, the dry time of the inkjet ink composition is less than or equal to about 20 seconds.

5. The inkjet ink composition as defined in claim 4 wherein the substantially non-absorbent substrate is selected from polypropylene tapes, polyester tapes, polyethylene bags, aluminum foil, glass, polyethylene substrates, high-density polyethylene substrates, water-resistant envelopes, and combinations thereof.

6. The inkjet ink composition as defined in claim 1, further comprising surfactants, biocides, buffers, or combinations thereof.

7. The inkjet ink composition as defined in claim 1 wherein the colorant is present in an amount ranging from about 3 wt. % to about 6 wt. %.

8. A method for forming an image on a substrate, comprising:
establishing an inkjet ink on at least a portion of the substrate, the inkjet ink including:
an acrylic latex present in an amount ranging from about 1 wt. % to about 5 wt. %;
a solvent selected from dipropylene glycol monomethyl ether, tetrahydrofurfuryl alcohol, propylene glycol monopropyl ether, and combinations thereof, the solvent present in an amount ranging from about 6 wt. % to about 10 wt. %;
1,2-hexanediol present in an amount ranging from about 0.5 wt. % to about 2 wt. %;
a colorant present in an amount ranging from about 0 wt. % to about 6 wt. %;
a dispersant; and
water;
wherein when the inkjet ink is established on a substantially non-absorbent substrate, the dry time of the ink is substantially reduced.

9. The method as defined in claim 8 wherein the colorant is selected from pigments, dyes, and combinations thereof.

10. The method as defined in claim 8 wherein the substantially non-absorbent substrate is selected from polypropylene tapes, polyester tapes, polyethylene bags, aluminum foil, glass, polyethylene substrates, high-density polyethylene substrates, water-resistant envelopes, and combinations thereof.

11. The method as defined in claim 8 wherein establishing is accomplished by thermal inkjet printing or piezoelectric inkjet printing.

12. The method as defined in claim 11 wherein thermal inkjet printing is accomplished using a portable thermal inkjet printer, a desktop thermal inkjet printer, a portable piezoelectric inkjet printer, a desktop piezoelectric inkjet printer, or combinations thereof.

13. The method as defined in claim 11 wherein the substantially reduced dry time is less than or equal to about 20 seconds.

14. The method as defined in claim 8 wherein the colorant is present in an amount ranging from about 3 wt. % to about 6 wt. %.

15. A printing system, comprising:
a printer; and
an inkjet ink configured to be printed, via the printer, on a substantially non-absorbent substrate, and to have a reduced dry time when printed on the substantially non-absorbent substrate, the inkjet ink including:
an acrylic latex present in an amount ranging from about 1 wt. % to about 5 wt. %;
a solvent selected from dipropylene glycol monomethyl ether, tetrahydrofurfuryl alcohol, propylene glycol monopropyl ether, and combinations thereof, the solvent present in an amount ranging from about 6 wt. % to about 10 wt. %;
1,2-hexanediol present in an amount ranging from about 0.5 wt. % to about 2 wt. %;
a colorant present in an amount ranging from about 0 wt. % to about 6 wt. %;
a dispersant; and
water.

16. The system as defined in claim 15 wherein the colorant is selected from pigments, dyes, and combinations thereof.

17. The system as defined in claim 16 wherein the dispersant is selected from styrene/acrylic acid copolymer resins.

18. The system as defined in claim 15 wherein the substantially non-absorbent substrate is selected from polypropylene tapes, polyester tapes, polyethylene bags, aluminum foil, glass, polyethylene substrates, high-density polyethylene substrates, water-resistant envelopes, and combinations thereof.

19. The system as defined in claim 15 wherein the printer is a thermal inkjet printer or a piezoelectric inkjet printer.

20. The system as defined in claim 19 wherein the thermal inkjet printer is selected from a handheld thermal inkjet printer, a desktop thermal inkjet printer, and combinations thereof.

21. The system as defined in claim 19 wherein the piezoelectric inkjet printer is selected from a handheld piezoelectric inkjet printer, a desktop piezoelectric inkjet printer, and combinations thereof.

22. The system as defined in claim 15 wherein the substantially reduced dry time is less than or equal to about 20 seconds.

23. The system as defined in claim 15 wherein the colorant is present in an amount ranging from about 3 wt. % to about 6 wt. %.
